(19) United States
(12) Patent Application Publication
(10) Pub. No.: US 2021/0386608 A1
(43) Pub. Date: Dec. 16, 2021

(54) Low Vibration Delivery System

(71) Applicant: Jonathan Carl Hoefs, Boulder Creek, CA (US)

(72) Inventor: Jonathan Carl Hoefs, Boulder Creek, CA (US)

(21) Appl. No.: 17/380,792

(22) Filed: Jul. 20, 2021

(51) Int. Cl. A61H 1/00; A61H 23/02

(52) U.S. Cl. CPC A61H 1/005; A61H 2201/0165; A61H 2203/0443; A61H 23/0245

(57) ABSTRACT

Improved low vibrational delivery system, suitable for individual to lie or sit upon and receive vibration. Multiple layers of vibrational attenuation iterative internally within design facilitate the optimized delivery, especially with regards to low vibrations. Key methodologies with regards to structural stability and the functional, unimpeded localization of resonators completes the novel, coherent design for optimized vibrational delivery which this invention embodies.

### CROSS-REFERENCE TO RELATED APPLICATIONS

This is a continuation of Provisional Patent Application No.: 63/199,197

### CLASSIFICATIONS

A61M21/02

A61M2021/0022

A61M2021/0027

### BACKGROUND OF THE INVENTION

The audible range of conscious human perception (Roughly 20 Hz-20,000 Hz) has been the natural launching-off point for technology which exploits sound and vibration's potential for producing therapeutic value; whether this is conceived of as “relaxing”, “meditative”, or any other relevant conception of “therapeutic”. As technology has expanded its' capacity for transmitting vibrations beyond, and significantly, beneath, this range, considerations of the somato-sensory experience beyond conscious human perception have concomitantly become relevant in new and significant ways. Critically, they have become terrain for important novel art in the field, parallel to the fashion in which advances in speaker technology have facilitated novel art in the musical field historically.

In order for this territory to expand more fully, design must be introduced which capitalizes upon these technological means and open new doors for practitioners generating signal delivered to these devices. A few key points, as well as a very brief overview of the problems with existing technologies which have attempted to address these domains, follows:

1. Efficiency of vibrational communication

Early incarnations of vibrational tables and mats did not adequately take into account the degree of vibrational activity lost through contact with the ground, as well as to parts physically affixed to the primary resonator(s) of these devices.

Maximal efficiency of vibrational communication ensures that as much of the produced vibration is delivered to the clients' body, rather than being unnecessarily siphoned off into the ground or affixed parts. Due to the intrinsic loss of unique vibratory bandwidths during this “siphoning off” process, maximal efficiency of vibratory communication also ensures that the fidelity of the vibrational signal is reproduced faithfully, which is crucial to the advancement of the art, and thus difficult to understate.

2. Structural stabilization in a vibrating system

The degree of stress which low vibrations impart to parts, as well as to the whole of a vibrating system, necessitate unique structural solutions. These must attenuate potential stress-related problems, as well as potentiate an optimized vibrational system by providing the unique structural support necessary to counteract the degree/nature of the vibration introduced. Normal structural solutions (i.e. those employed in the design of a traditional bed or table) will not fully suffice to meet these demands.

### BRIEF SUMMARY OF THE INVENTION

The invention is a novel vibrational system for therapeutic application. The client lies upon a fabric covered foam surface. A primary resonating body free-floating between multiple layers of foam faithfully reproduces the most complex vibrational signals delivered (between 5 and 200 Hz), providing optimized therapeutic benefit.

The design addresses each of the points relevant to expansion of the art of the field, as introduced in the “Background” section:

1. Efficiency of Vibrational Communication

The invention achieves maximal vibrational communication through several methods. The first is vibrational isolation, which in turn occurs in several layers of expression: those provided in the base, and those provided in the free-floating design of the foam/primary vibrating body assembly itself. Each of these elements of the design in turn employ multiple layers of methodology, each internal to their own processes, creating iterative optimization within the overall articulated design:

1) Vibrational Isolation of the Table Base:

As mentioned before, prior incarnations of the vibrational table/mat/chair lost considerable vibration via contact with the ground (an example of this may be found in U.S. Pat. No. 7,108,654B2, which affords ample attention to multi-sensory experience, but not adequate attention to vibrational attenuation). Frequently these devices have been observed to unnecessarily vibrate an entire house while a client was lying upon them. The invention employs two layers of vibrational isolation within the design of the base specifically:

First, vibrational isolation feet, strategically arranged in a geometric pattern which emphasizes the unique weight distribution of the human form, effectively isolate the foam/primary vibrating body assembly from the ground.

Second, vibrational isolation pads/washers placed on the adjoining bolts of these feet, both above and below the base, afford a second layer of isolation between the foam/primary vibrating body, and the ground.

Thus two layers of vibrational isolation exist in the design of the base itself, “floating” the system, and ensuring that the vibrations produced by the primary vibrating body efficiently conduct upwards into the clients' body, and not into the ground or other elements of the system.

2) Free-Floating Design of the Foam/Primary Vibrating Body Assembly:

If any part of the primary vibrating body is affixed in any way, whatever it is affixed to becomes a part of that vibrating system, and will tend to “siphon off” its' vibrational activity. Hence a free floating design is necessary.

There are two layers of vibrational isolation employed to achieve the free-floating design of the foam/primary vibrating body assembly:

1—The resonator(s) are sandwiched between two layers of foam vertically, and an intermittent layer of foam horizontally, effectively “floating” the primary vibrating body.

2—The tension of the fabric massage cover would naturally “hold in” the resonators and impede vibration in a design which did not account for this; the directly applied tension of the corners would thus “siphon off” the primary vibrating bodies' activity vibrationally.

Diagonal cuts in the exterior corners of the resonators ensure that they float freely within the foam layers without being “held in” by the vinyl cover, thus creating two layers of vibrational isolation within the design of the foam/primary vibrating body assembly itself.

2. Structural Stabilization in a Vibrating System

Generally speaking, a human body will locate the primary weight demand upon the vibrating system towards the systems' midline, and in the contour of the human form. The diamond shaped arrangement of the feet, isomorphic to the human contour, maximizes structural support for the vibrating system, and the unique demands placed upon it. This ensures that both the invention, as well as the client lying upon it, receive the needed structural support.

### BRIEF DESCRIPTION OF THE SEVERAL VIEWS OF THE DRAWING

FIG. 1 is a side view of the invention.

FIG. 2 is a close up side view of the feet assembly and base.

FIG. 3 is a side view of resonator assembly, including resonator and transducer.

FIG. 4 is a side view of the three foam layers.

FIG. 5 is a bottom view of base.

FIG. 6 is a cross-sectional top view of central and bottom foam layers with resonators in place.

### DETAILED DESCRIPTION

Invention provides improved vibrational delivery through iterative degrees of vibrational attenuation, designed to direct vibrational communication in a highly targeted fashion, into the human organism. Embodiments exist with one or more transducers (6), a corresponding number of soundholes (3), variations on the feet design, etc. which maintain the core, novel elements of the invention. For purposes of this description/visual illustration, a basic embodiment with 2 transducers (6), and 2 soundholes (3) is described.

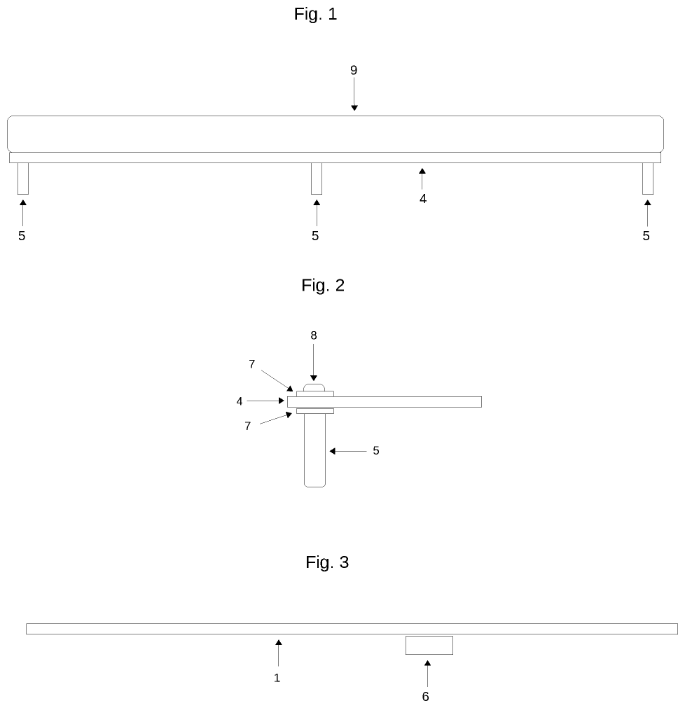

FIG. 1 illustrates fundamental structural design of the device in described embodiment. Vibrational isolation feet (5) are affixed to base (see FIG. 2 for close up and detail). Fabric cover (9) holds in the primary vibrating body assembly, which includes resonators, transducers, and enclosing foam.

FIG. 2 shows close up of vibrational isolation feet (5). These are affixed to base via bolts (8) or appropriate attachment assembly (in the case of pre-fabricated vibrational isolation feet). Vibrational isolation pads/washers (7) placed above/below base to provide further vibrational dampening between base and feet assembly. Thus vibrational isolation is created between ground and feet via vibrational isolation properties of feet themselves, as well between feet and base, via vibrational isolation pads/washers.

FIG. 3 shows side view of resonator (1) bolted to transducer (6).

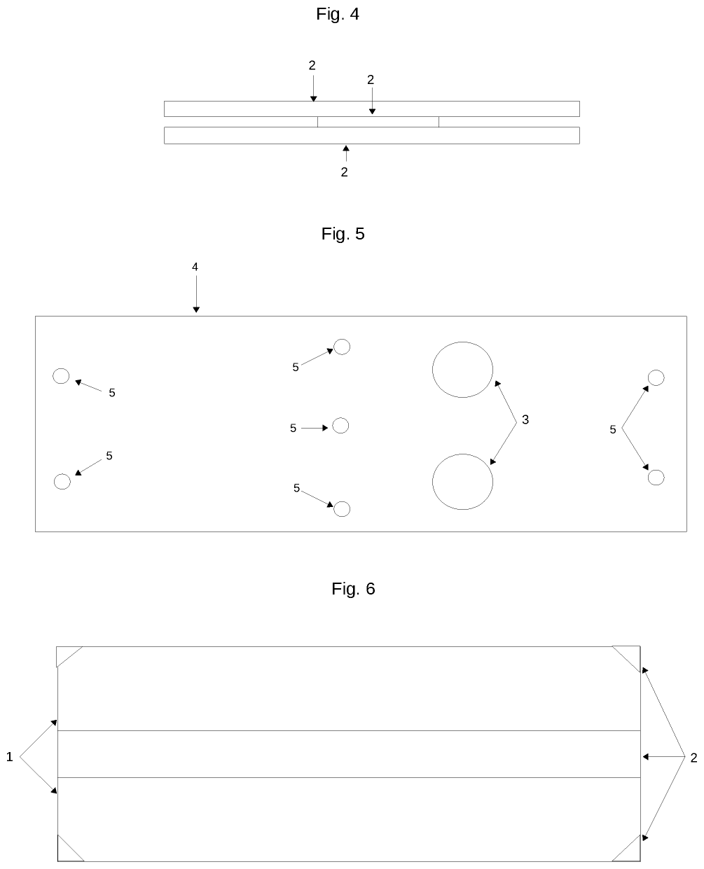

FIG. 4 is a cross-sectional view of the foam assembly, from top of device looking down. In this design, three layers of foam (2) create space for two resonators (1) to vibrate freely within. Resonators (1) are placed on either side of a mid-longitudinal layer of foam cut to the appropriate width to create this space for the resonators.

FIG. 5 is a bottom view of the base (4). Transducers (6) rest in/through space provided by two holes in base (3), allowing them to cool, as well as to vibrate freely. Seven vibrational feet (5) (in this design), arranged in a pattern isomorphic to the human form, provide needed structural support for device and client.

FIG. 6 is a top-view of the bottom two layers of foam (2) with resonators (1) in place. It illustrates diagonal cuts on the outside corner of the resonators, as well as the mid-longitudinal region of foam designed to prevent vibrational communication between the two resonators.

Client is placed upon device, with headphones on. Using amplifier(s) appropriate to driving both transducer(s) and headphones, vibration and sound is delivered. Through 1) the activity of hearing, 2) the tactile sense, and 3) the stimulation of the nerves, relevant therapeutic value is achieved.

### RELATED PATENTS

U.S. Pat. No. 8,517,911B1—Sound delivery system for vibro-acoustic treatment
U.S. Pat. No. 9,949,004B2—Sound and vibration transmission device
U.S. Pat. No. 6,544,165B1—Method and apparatus for applying frequency vibrations therapeutically
U.S. Pat. No. 7,918,308B2—Sound and vibration transmission pad and system
U.S. Pat. No. 7,108,654B2—A kind of electric massage shaking table with monitoring function
US20070093732A1—Vibroacoustic sound therapeutic system and method
US20080125620A1—Apparatus, system, and method for creating an individually balanceable environment of sound and light
U.S. Pat. No. 7,981,064B2—System and method for integrating transducers into body support structures
U.S. Pat. No. 5,097,821A—Somatic musical exposure system
U.S. Pat. No. 5,143,055A—Somatic acoustic chair
CN101909490B—Chair and system for transmitting sound and vibration

I claim:

1) A vibrational delivery system, which optimizes the efficiency of vibrational delivery to the human body, by creating multiple levels of vibrational isolation from vibrational communication between resonators and other elements of the system, and resonators and surrounding environment, which consists of:
Resonator(s), each with a transducer attached;
Foam enclosure, such that resonator(s) is/are contained within the foam, and is/are isolated from vibrational communication with other resonator(s);
Fabric cover, which holds resonator(s) in place along with foam, without causing resonator(s) to be affixed to any other element(s) of the table;
Circular hole(s) in base, which allow transducer(s) to 1) physically rest in the space they provide, 2) be depressed by the weight of the human body, and 3) vibrate unimpeded by contact with the base itself;
A table base, with vibrational isolation legs attached, which are in turn isolated from vibrational communication with the base via vibrational isolating pads/washers placed on leg attachment fixtures both above and below base.

2) An arrangement of feet on table base isomorphic to the contour of the human body, which provides strategic structural support with regards to the unique vibrational demands of the system.

3) Diagonal cuts in the corners of the resonator(s) corresponding to the corners of the table, which allow fabric cover to hold resonator(s) in place with minimal impact on resonators' vibrational activity.
